(19) United States
(12) Patent Application Publication
(10) Pub. No.: US 2024/0399312 A1
(43) Pub. Date: Dec. 5, 2024

(54) MEMBRANE FILTRATION CELL WITH ELECTRIC FIELD AND ACOUSTIC FIELD

(71) Applicant: University of Vermont and State Agricultural College, Burlington, VT (US)

(72) Inventors: Appala Raju Badireddy, Burlington, VT (US); Yuxiang Shen, Burlington, VT (US)

(73) Assignee: University of Vermont and State Agricultural College, Burlington, VT (US)

(21) Appl. No.: 18/695,123

(22) PCT Filed: Sep. 28, 2022
(86) PCT No.: PCT/US22/44976

§ 371 Date: Mar. 25, 2024

Related U.S. Application Data
(60) Provisional application No. 63/251,072, filed on Oct. 1, 2021.

(51) Int. Cl. B01D 65/08; B01D 63/08; C02F 1/44

(52) U.S. Cl. CPC B01D 65/08; B01D 63/087; C02F 1/44; B01D 2313/201; B01D 2313/345; B01D 2313/36; B01D 2315/10; B01D 2321/2075; B01D 2321/22; B01D 2321/44; C02F 2303/20

(57) ABSTRACT

A membrane filtration cell is provided which includes a fluid passageway and a filtration membrane positioned within the passageway, the filtration membrane dividing the fluid passageway into two chambers, a retentate chamber and a permeate chamber. A first electrode is positioned in the retentate chamber and a second electrode is positioned in the permeate chamber, where the first electrode and the second electrode are configured to apply an electric field across the filtration membrane. The membrane filtration cell also includes an acoustic device configured to apply an acoustic field across the retentate chamber, where the synergistic combination of the electric field and the acoustic field prevents fouling on the filtration membrane. A method of filtering water is provided which includes generating an electric field across a filtration membrane with a first electrode positioned in the retentate chamber and a second electrode positioned in the permeate chamber, and generating an acoustic field across the retentate chamber with an acoustic device, where the synergistic combination of the electric field and the acoustic field prevents fouling on the filtration membrane.

### RELATED APPLICATIONS

The present application claims the benefit under 35 U.S.C. § 119(e) to U.S. Provisional Application No. 63/251,072 filed on Oct. 1, 2021, the contents of which is incorporated by reference herein in its entirety.

### FIELD OF THE INVENTION

The invention relates, in part, to a membrane filtration cell and methods of filtering water with a membrane filtration cell which utilizes both an electric field and an acoustic field.

### BACKGROUND

In a filtration system, such as a water treatment system, it may be desirable to remove one or more compositions from the water stream, which may be considered contaminants in the water stream.

### SUMMARY OF THE INVENTION

In one aspect, a membrane filtration cell is provided which includes a fluid passageway and a filtration membrane positioned within the passageway, the filtration membrane dividing the fluid passageway into two chambers, a retentate chamber and a permeate chamber. The membrane filtration cell also includes a first electrode positioned in the retentate chamber, a second electrode positioned in the permeate chamber, where the first electrode and the second electrode are configured to apply an electric field across the filtration membrane. The membrane filtration cell also includes an acoustic device configured to apply an acoustic field across the retentate chamber, where the synergistic combination of the electric field and the acoustic field prevents fouling on the filtration membrane.

In another aspect, a method of filtering water is provided which includes providing a filtration membrane in a fluid passageway, the filtration membrane dividing the fluid passageway into a retentate chamber and a permeate chamber, and flowing water into the retentate chamber. The method also includes generating an electric field across the filtration membrane with a first electrode positioned in the retentate chamber and a second electrode positioned in the permeate chamber, and generating an acoustic field across the retentate chamber with an acoustic device, where the synergistic combination of the electric field and the acoustic field prevents fouling on the filtration membrane.

### BRIEF DESCRIPTION OF THE DRAWINGS

FIG. 1A is a schematic diagram of one embodiment of a system which includes a membrane filtration cell;

FIG. 1B is a conceptual view of the proposed mechanisms of the AC electric and acoustic fields according to one embodiment;

FIG. 2 illustrates the inside of a membrane filtration cell according to one embodiment;

FIG. 3 illustrates a piezoelectric transducer on a membrane filtration cell according to one embodiment;

FIG. 4 is a close up view of the membrane filtration cell shown in FIG. 3;

FIG. 5 is a graph which compares the steady state specific flux for different combinations of applying an electric field and/or applying an acoustic field;

FIG. 6 is a perspective view of a first plate which may form a portion of a membrane filtration cell according to one embodiment;

FIG. 7 is another perspective view of a first plate which may form a portion of a membrane filtration cell according to one embodiment;

FIG. 8 is a cross-sectional view of the first plate shown in FIGS. 6-7;

FIG. 9 is another cross-sectional view of the first plate shown in FIGS. 6-7;

FIG. 10 is a perspective view of a second plate which may form a portion of a membrane filtration cell according to one embodiment;

FIG. 11 is another perspective view of a second plate which may form a portion of a membrane filtration cell according to one embodiment;

FIG. 12 is a graph illustrating the variation of experimental flux due to electric field strength according to one embodiment;

FIG. 13 is another graph illustrating the variation of experimental flux due to electric field strength according to one embodiment;

FIG. 14 is a graph illustrating the variation of experimental flux due to acoustic field frequency according to one embodiment;

FIG. 15A is a graph illustrating the Zeta potential measurements of foulants and track-etched polycarbonate membrane surface in synthetic wastewater at pH 6, 8.3, and 10;

FIG. 15B is a graph illustrating the hydrodynamic size measurements of foulants in synthetic wastewater at pH 6, 8.3, and 10;

FIG. 16 is a graph illustrating the variation of experimental flux due to pH according to one embodiment;

FIG. 17 is a graph illustrating the variation of experimental flux due to foulant composition according to one embodiment;

FIG. 18 is a graph illustrating the variation of experimental permeate flux due to the presence and absence of the electric field or acoustic field according to one embodiment;

FIG. 19 is a graph illustrating the experimental permeate flux results of 2² two-level factorial setup according to one embodiment;

FIG. 20 includes Table 1 which lists the composition of the synthetic wastewater according to one embodiment;

FIG. 21 includes Table 2 which lists experiment parameters in single-variable experiments according to one embodiment;

FIG. 22 includes Table 3 which lists ANOVA results of treatment groups with variation of electric field strength according to one embodiment;

FIG. 23 includes Table 4 which ANOVA results of treatment groups with variation of acoustic field frequency according to one embodiment;

FIG. 24 includes Table 5 which lists ANOVA results of treatment groups with variation of pH according to one embodiment;

FIG. 25 includes Table 6 which lists ANOVA results of treatment groups with variation of foulant composition according to one embodiment;

FIG. 26 includes Table 7 which lists 2² two-level factorial design of the experiment, including electric field strength and acoustic field strength according to one embodiment; and

FIG. 27 includes Table 8 which lists ANOVA results of the 2² two-level factorial setup according to one embodiment.

### DETAILED DESCRIPTION

One aspect of the present disclosure is directed to a water treatment system which includes a membrane filtration cell which is configured to remove one or more compositions (i.e. particles or ions) from the water stream.

Aspects of the present disclosure are directed to a membrane filtration cell configured to apply an electric field across the membrane. For example, as set forth in more detail below, the water treatment system may include a filtration membrane, a first electrode and a second electrode. The electrodes may be configured to apply an electric field across the membrane.

Further aspects of the present disclosure are directed to a membrane filtration cell configured to apply an acoustic field. As set forth in more detail below, the inventors recognized that the synergistic combination of the electric field and the acoustic field prevents fouling on the filtration membrane.

In one embodiment, the membrane may be configured in a dead end filtration system. In another embodiment, the membrane may be configured in a cross flow filtration system. It is contemplated that in a cross flow filtration system, the particles may be carried away by the cross flow, and thus removed from the feed water.

One embodiment of the present disclosure is directed to a cross-flow flat sheet filtration cell that is configured to apply an electric field and/or acoustic field. In one embodiment the device allows pressurized membrane filtration of microfiltration and ultrafiltration which require a transmembrane pressure of up to 40 psi. It is contemplated that in another embodiment, nanofiltration and reverse osmosis filtration may also be employed which require a higher transmembrane pressure. As outlined below, the device may include two electrodes within the cell at a small separating distance from the membrane to apply a direct current or alternative current electric field. In one embodiment, the device may also include an acoustic piezoelectric transducer exterior to the cell at a small separation distance from the filtration chambers. The device may apply an electric field and/or an acoustic field to enhance the filtration efficiency. The device separates feed water into permeate water, which is the clean final product, and retentate water, which may be recycled and reused as feed water.

The device also provides a research tool to investigate the fouling mitigation effects under the electric field and acoustic field. It is contemplated that the membrane filtration cell and methods discussed below may be used in further research of non-chemical based water filtering. It is also contemplated that the membrane filtration cell and methods discussed may be used in larger scale commercial applications to provide clean permeate water. In one embodiment, the device could be used in a domestic water treatment system in situations which may require a higher water standard for domestic use. The device could also provide “point-to-use” treatment powered by battery or solar energy.

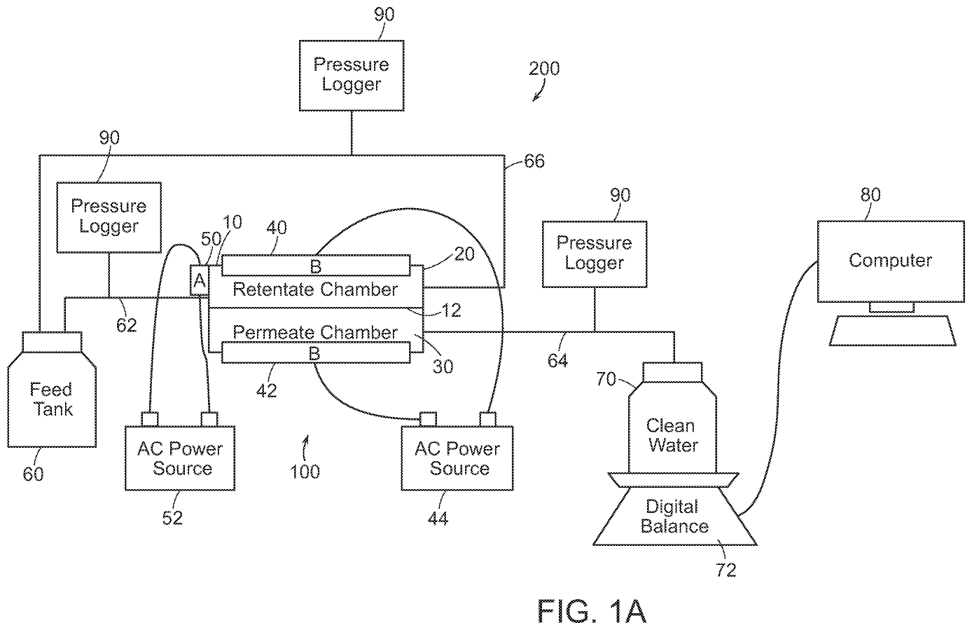

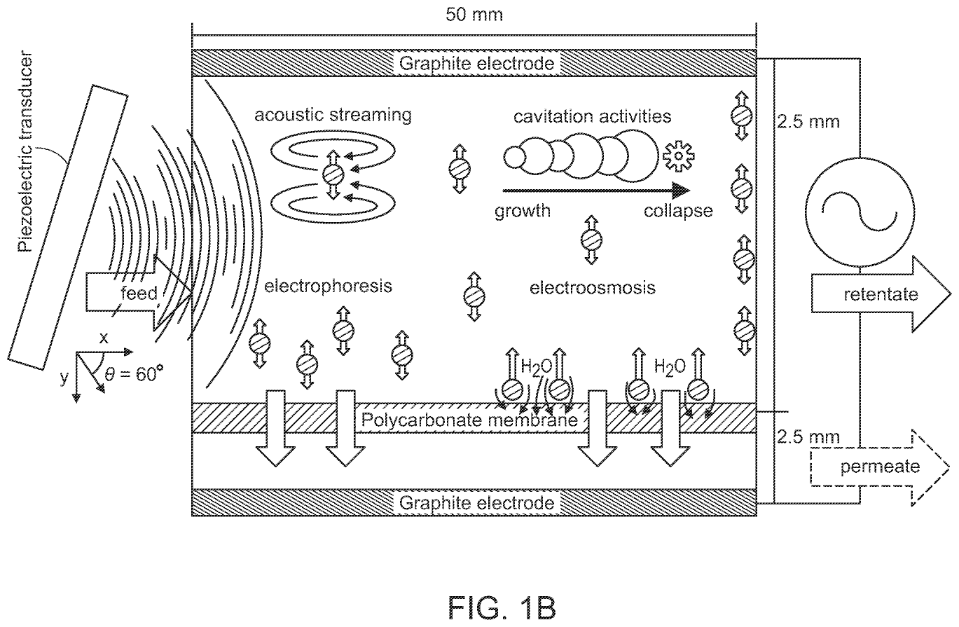

Turning now to FIG. 1, a schematic diagram of one embodiment of a field-assisted microfiltration system 200 including a membrane filtration cell 100 is illustrated. As shown, the membrane filtration cell 100 is configured in a cross flow filtration system and includes a fluid passageway 10, with a membrane 12 positioned within the passageway 10. As shown, the membrane 12 divides the fluid passageway 10 into two chambers, a retentate chamber 20 and a permeate chamber 30. A first electrode 40 is positioned in the retentate chamber 20 and a second electrode 42 is positioned in the permeate chamber 30. The first and second electrodes 40, 42 are configured to apply an electric field across the membrane 12.

The inventors previously recognized that the application of an electric field across the membrane 12 prevents fouling on the membrane. For example, U.S. application Ser. No. 17/272,782, filed Mar. 2, 2021 and U.S. 63/011,445, filed Apr. 17, 2020 are both directed to membrane filtration configurations where an electric field is applied across the membrane, the contents of both applications are incorporated by reference in their entirety.

As shown in FIG. 1, the membrane filtration cell 100 also includes an acoustic device 50 configured to apply an acoustic field across the retentate chamber 20. As set forth in more detail in the experiments outlined below, the inventors recognized that the combination of the electric field and the acoustic field prevents fouling on the filtration membrane 12. Thus, aspects of the present disclosure are directed to the synergistic combination of using both an electric field and an acoustic field to prevent membrane fouling.

As shown in FIG. 1, a first power source 44 may be configured to apply the electric field across the filtration membrane 12. In one embodiment, the first power source 44 is an AC power source that is coupled to both the first and second electrodes 40, 42. A second power source 52 may be configured to apply the acoustic field across the retentate chamber 20. In one embodiment, the second power source 52 is a function generator that is coupled to the acoustic device 50. Other types of known power sources are also contemplated, as the disclosure is not so limited. It is also contemplated that in one embodiment, one power source may be used.

As also shown in FIG. 1, a feed tank 60 may be provided upstream of the membrane filtration cell 100. Tubing 62 forms a feed path, and the water (or other fluid to be filtered) flows from the feed tank 60 and through the retentate chamber 20 where the clean water passes through the membrane 12 and into the permeate chamber 30. A clean tank 70 is provided downstream of the membrane filtration cell 100, and tubing 64 forms the permeate path and connects the permeate chamber 30 to the permeate tank 70 (i.e. clean tank). A digital balance 72, or other measuring device measures the amount of clean water that enters the clean tank 70. A computer 80 may be coupled to the balance 72 to calculate the amount of clean water that is filtered through the membrane filtration cell 100.

Tubing 66 forms a retentate path and provides a closed loop for retentate water to exit the membrane filtration cell 100 and circle back into the feed tank 60. This water may be recirculated through the membrane filtration cell 100. A pressure gauge for real-time pressure monitoring and one or more pressure loggers 90 may be installed along tubing 62, 64, 66 to record pressure within the feed path, permeate path, and the retentate path. In one embodiment, the tubing 62, 64, 66 is Nalgene tubing with a 0.25 inch outer diameter. In one embodiment, a 10 L polycarbonate carboy may be used as the feed/retentate tank 60 to store and supply the feed water to the filtration cell and also receive the retentate water returning from the filtration cell. Tubing 62 forms the feed path and connects the feed tank 60 to the fluid passageway 10. Another 10 L polycarbonate carboy may be used as the permeate tank 70 to receive and store the permeate water from the filtration cell. A peristaltic pump may be installed in between the feed/retentate tank 60 and the filtration cell 100 on the feed pathway to send feed water into the filtration cell 100. A pulsation dampener may also be installed on the feed pathway to smooth the flow. A back-pressure regulator may be installed between the filtration cell 100 and the feed/retentate tank 60 to provide the transmembrane pressure required for membrane filtration. One of ordinary skill in the art will appreciate that in another embodiment, the microfiltration system 200 may be configured differently. For example, it should be appreciated that in commercial applications, larger components may be desired.

FIG. 1B is a conceptual view of the proposed mechanisms according to one embodiment. As shown, a membrane filtration cell may include opposing electrodes that are configured to apply an electric field across a filtration membrane. As set forth in more detail below, electrophoresis and electroosmosis are associated with the electric field. As shown, the membrane filtration cell 100 may also include an acoustic device which is configured to apply an acoustic field. As set forth in more detail below, cavitation activities and acoustic streaming are associated with the acoustic field.

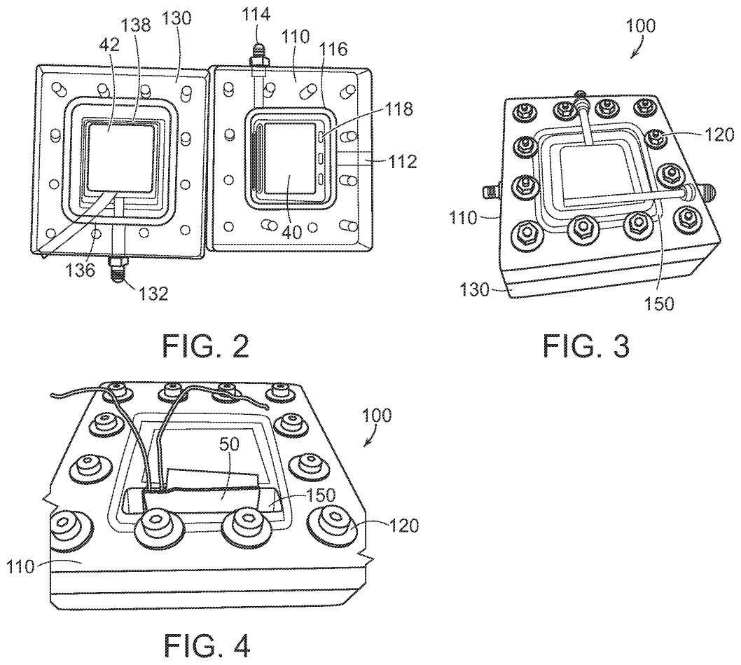

Turning now to FIGS. 2-4 which illustrate one embodiment of the membrane filtration cell 100 that includes a first plate 110 and a second plate 130. The first and second plates 110, 130 may be stacked together as shown in FIG. 3, with the filtration membrane 12 positioned there between to form the filtration cell 100. The first plate 110 may include a concavity 118 which forms the retentate chamber 20, and likewise, the second plate 130 may have a concavity 138 which forms the permeate chamber 30. As shown in FIG. 2, the first electrode 40 may be positioned within the concavity 118 in the first plate 110 and the second electrode 42 may be positioned within the concavity 138 formed in the second plate 130. As shown in FIG. 1, in one embodiment, the first electrode 40 is substantially parallel to the filtration membrane 12 and the second electrode 42 is also substantially parallel to the filtration membrane 12. In this configuration, the first and second electrodes 40, 42 are configured to apply an electric field perpendicular to the membrane 12. In one embodiment, the first and second electrodes 40, 42 are spaced apart a distance of approximately 5 millimeters.

As shown in FIG. 4, in one embodiment, the acoustic device 50 is coupled to the first plate 110. In this particular embodiment, the first plate 110 includes a groove 150 configured to receive the acoustic device 50. The groove 150 is also shown in FIGS. 7-9 and is described in more detail below.

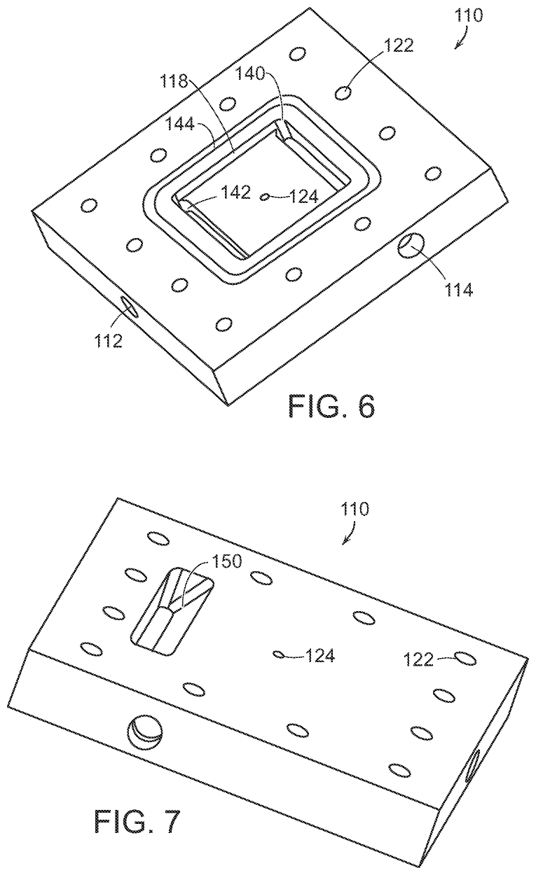

In one embodiment, the first and second plates 110, 130 are two shells cut from a polycarbonate block. Each plate 110, 130 may have a general dimension of about 5 inches×5 inches with a 0.75 inch height. As shown in FIGS. 3 and 4, the two plates 110, 130 are stacked together and tightened by a plurality of bolts 120, which may be distributed along the periphery. A hole 124 (see FIG. 6) may be drilled at the center of both plates 110, 130 to allow stainless wires into the cell 100 to connect with the electrodes 40, 42 to connect the electrodes 40, 42 to their respective power sources 44, 52. The holes 124 may be sealed with epoxy. The inside of each plate 110, 130 has a concavity 118, 138 that forms the retentate chamber 20 and permeate chamber 30. In one embodiment, the concavities 118, 138 have a depth of 0.1875 inches and an area of 2.25 inches×2.25 inches at the center for electrode installation. The membrane 12 may be placed between the plates 110, 130 and sealed by O-rings 116, 136 on each side of the membrane. All inlets/outlets 112, 114, 132 may be cut as ⅛ NPT thread pipe fitting size.

In one embodiment, the first and second plates 110, 130, (also known as “shells”) of the filtration cell 100 are made of polycarbonate. In another embodiment, the plates 110, 130 may be made of materials including, but not limited to, stainless steel or other metallic materials, polyester or other polymer materials. In one embodiment, the filtration membrane 12 is made of polycarbonate. In another embodiment, the membrane 12 may be made of other materials, including, but not limited to, polyester, polypropylene or other polymer materials, aluminum oxide, titanium oxide or other ceramic materials. In one embodiment, the first and second electrodes 40, 42 are made of carbon paper. In another embodiment, the electrodes 20, 42 may be made of materials including but not limited to titanium, stainless steel or other metallic materials, reduced graphene oxide or other conductive non-metallic materials. In one embodiment, the acoustic device 50 is a piezoelectric transducer made of a ceramic material. In another embodiment, the acoustic device 50 may be made of other materials including, but not limited to, lead-based piezoelectric materials, KNN-based piezoelectric ceramics, bismuth-based piezoelectric ceramics, electropholymers, and carbon-fiber composite materials. Furthermore, the dimension of the filtration cell, the angle of installation of the electric field and acoustic field may vary based on the setup.

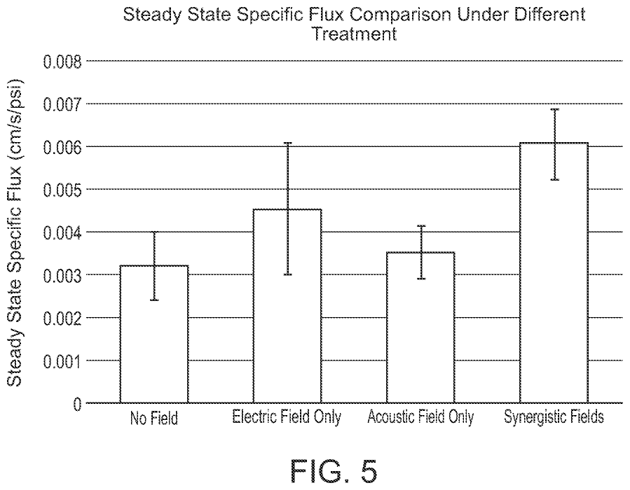

FIG. 5 is a graph which compares the steady state specific flux for different combinations of applying an electric field and/or applying an acoustic field. As outlined in more detail below, through experimentation with the membrane filtration cell 100 shown in FIGS. 2-4, the inventors recognized that the synergistic combination of both the electric field and the acoustic field provided a higher steady state specific flux in comparison to electric field only, acoustic field only, or no field. During this experiment, a 0.2 μm pore diameter membrane was used with a transmembrane pressure of 10 psi, at room temperature of 20° C. The electric field was a 10V p-p alternative electric field, and the acoustic field was a 500 kHz acoustic field.

Turning now to FIGS. 6-9, the first plate 110 will now be further described. As shown in FIG. 6, on one side of the first plate 110 is a concavity 118 which forms the retentate chamber 20. The first plate 110 also has inlet/outlet ports 112, 114. As shown, the first plate 110 has two grooves 140, 142 cut along the opposite edges of the bottom of the concavity 118. As shown, the inlet or outlet 112, 114 may be connected to each of the grooves 140, 142 for the feed water to enter and the retentate to leave the cell 100. In one embodiment, the grooves 140, 142 are 0.1875 inches wide, 0.5 inches deep and 2.25 inches long. The first plate 110 may also have a plurality of through holes 122 to secure the above-described bolts 120. As also shown, there may be a rectangular O-ring groove 144 around the concavity 118 to receive the O-ring 116.

The inventors recognized that an acoustic device 50 positioned perpendicular to the membrane may be more likely to damage the membrane 12. Thus, aspects of the present disclosure are directed to an acoustic device 50 which is positioned at an angle relative to the filtration membrane 12 such that the acoustic field is not perpendicular to the filtration membrane.

For example, as shown in FIGS. 7-9, on the outer side of the first plate (opposite the concavity 118 on the inner side) there is a groove 150 configured to receive the acoustic device 50. In one embodiment, the groove 150 is cut into the outside of the plate 110 and is 0.5 inches wide at the opening, 0.25 inches wide at the bottom, 0.5 inches deep and 2.5 inches long. As shown in FIG. 9, in one embodiment, the groove wall 154 closer to the periphery of the plate 110 is substantially perpendicular to the outer plate surface 156, while the groove 150 also includes an angled wall 152 further from the periphery of the plate 110. The acoustic device 50 may be coupled to the angled wall 152 such that the acoustic device 50 is configured to apply an acoustic wave at an angle relative to the filtration membrane 12.

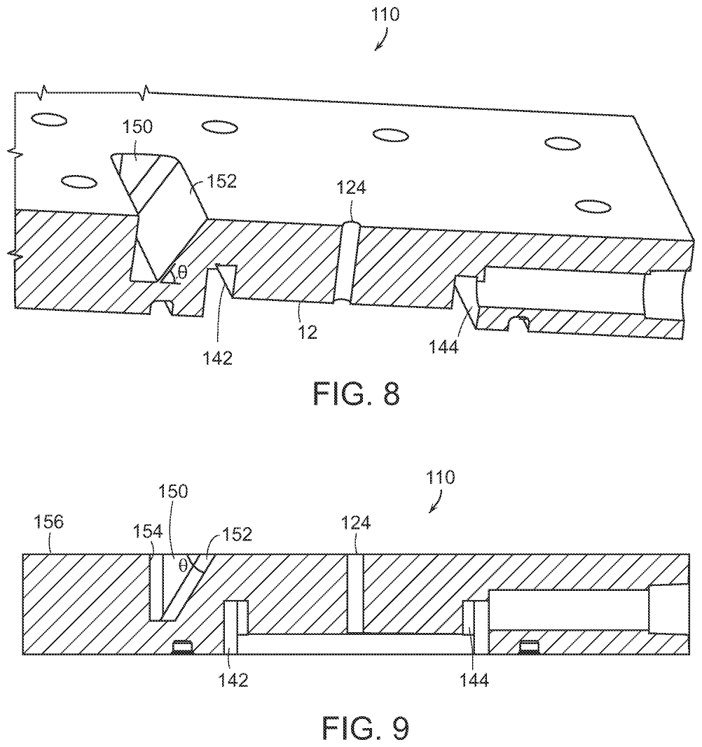

As shown in FIG. 8, the angled wall 152 forms an angle θ with the filtration membrane 12. As shown in FIG. 9, this angle θ is also equal to the angle that the angled wall 152 forms with the outer plate surface 156. In one embodiment, the angle θ that the angled wall 152 forms relative to the filtration membrane 12 is between about 10° and about 80°. In one particular embodiment, the angle θ is about 60° relative to either the filtration membrane 12 or the outer plate surface 156. In one embodiment, the acoustic device 50 is a ceramic piezoelectric transducer coupled to the angled wall 152.

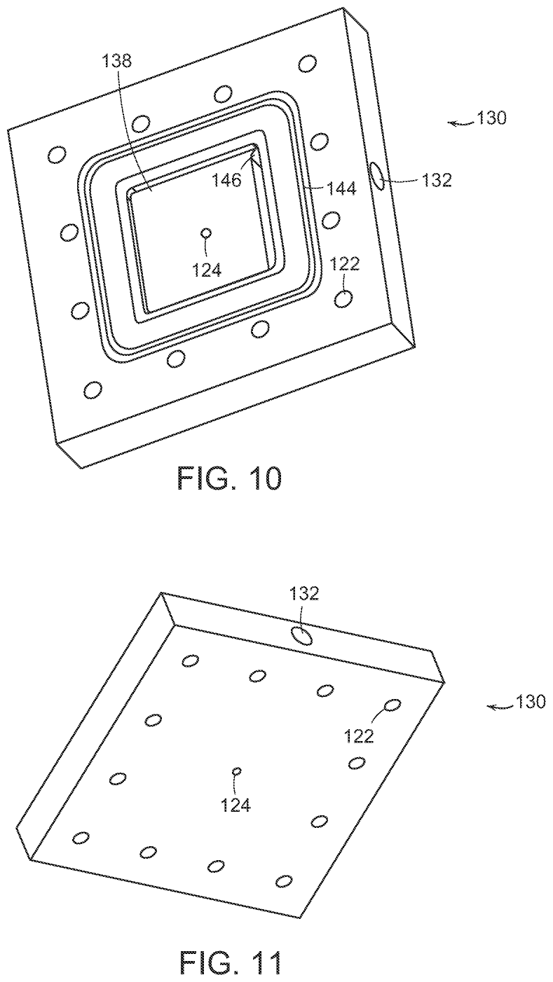

Turning now to FIGS. 10-11, the second plate 130 will now be further described. As shown in FIG. 10, on one side of the second plate 130 is a concavity 138 which forms the permeate chamber 30. The second plate 130 also has one or more inlet/outlet ports 132 for the permeate chamber 30. In one embodiment, a groove 146 is cut along one edge of the bottom of the concavity 138. As shown, the outlet 132 is connected to the groove 146 for the permeate water to exit. In one embodiment, the groove 146 is 0.1875 inches wide, 0.5 inches deep and 2.25 inches long. The second plate 130 may also have a plurality of through holes 122 to secure the above-described bolts 120. As also shown, there may be a rectangular O-ring groove 144 around the concavity 138 to receive the O-ring 136.

The inventors also recognized that there may be limited positions that a piezoelectric transducer can be installed, which limit the propagation direction of the acoustic wave. In one embodiment, this may be overcome by modifying the exterior shape of the membrane filtration cell 100. In one embodiment, the cell 100 may be limited to a maximum interior pressure of up to 30 psi. It is contemplated that this pressure limit could further be increased by designing an external removable exoskeleton to reinforce the device.

Aspects of the present disclosure are also directed to methods of filtering water, which may include providing a filtration membrane 12 in a fluid passageway 10, the filtration membrane 12 dividing the fluid passageway into a retentate chamber 20 and a permeate chamber 30, and flowing water into the retentate chamber 20. The method may also include generating an electric field across the filtration membrane 12 with a first electrode 40 positioned in the retentate chamber 20 and a second electrode 42 positioned in the permeate chamber 30, and generating an acoustic field across the retentate chamber 20 with an acoustic device 50, where the synergistic combination of the electric field and the acoustic field prevents fouling on the filtration membrane 12.

### EXAMPLES

As set forth below, the inventors demonstrated a setup of membrane filtration with the combined assistance of electric field and acoustic field to illustrate the synergistic effect of field assisted fouling mitigation on nano-scale particulate foulants in complex water matrix with a low energy consumption setup. To analyze the results, ANOVA test was used to identify the significance of each parameter that was studied, i.e. electric field strength, acoustic field frequency, foulant composition and pH. The results confirmed a positive effect on the field application to mitigate the fouling behavior contributed by the particulate foulants. Further optimization may further address the fouling behavior contributed by the dissolved foulants in the synthetic wastewater matrix.

### Theory

### Fouling Mechanisms

Membrane filtration process, similar to other processes that fluid passes through a porous media, is governed by Darcy's law that

$$J = \frac{Δ P}{μ ( {R}_{m} + {R}_{f} )} \qquad ( 1 )$$

where J is flux, ΔP is transmembrane pressure, μ is dynamic viscosity of the fluid, Rₘ is the membrane resistance, and R_{f} is the fouling resistance. In the filtration process, membrane fouling induces the increase of R_{f}, resulting in a reduced production of transmembrane flux. Membrane fouling has been known since the beginning of membrane techniques, and mature conceptual models have been developed by multiple researchers. In these earlier models of membrane filtration process, an assumption has been made that when a unit volume of feed water reaches the membrane surface, the clean water is separated and passes through this membrane as permeate, while all foulants in this unit volume is accumulated on the membrane surface. In the context of field assisted membrane filtration, this assumption may no longer be held valid. This will be further explained as the theories of electrofiltration and acoustofiltration are discussed.

To normalize the flux results with respect to the fluctuating transmembrane pressure due to flow pulsation from the peristaltic pump, specific flux was calculated by

$${J}_{s} = \frac{Q}{A \cdot Δ P} = \frac{J}{Δ P} \qquad ( 2 )$$

### Electrofiltration

In electrofiltration, two branches of mechanisms have been exploited to mitigate membrane fouling. One of the branches utilizes electrodynamics, including methods of electrophoresis and electroosmosis. Electrophoresis describes the phenomenon that charged particles or ions move along the direction of electric field gradient. Electroosmosis occurs in narrow channels. It describes when ions are moved by electrophoresis in these channels, water enters the void left behind by these ions, resulting in small flows. The other branch relies on electrochemistry, including methods of electrolysis and electrocoagulation. Electrolysis describes the redox reaction incurred by electric field in the fluid. Electrocoagulation refers to the coagulation incurred by magnesium or iron ions, which are produced from the sacrificial electrodes by electrolysis.

In the context of one experiment, a setup of alternative electric field with less than 20 Vpp electric field strength was used to avoid electrolysis, in order to avoid electrochemical reaction in the system, which may damage the membrane or produce treatment by-products from the synthetic wastewater. Chemically inert carbon paper was used as electrodes to avoid corrosion. In the literature of electrofiltration, an important concept is the critical electric field strength, which refers to the electric field strength that beyond which there is no further improvement in fouling mitigation. The electrophoretic phenomenon is described by Smoluchowski equation that

$${v}_{av} = \frac{{ε}_{r} {ε}_{0} ζ}{μ} {E}_{z} \qquad ( 3 )$$

where νₐᵥ is the average electrophoretic velocity, εᵣ and ε₀ are relative permittivity and permittivity in vacuum respectively, ξ is the zeta-potential, μ is the dynamic viscosity and E_{z} is the external electrical field. In an ideal electrofiltration setup, the settling velocity of the foulants towards the membrane is balanced by the electrophoretic velocity, and the fouling behavior is therefore minimized. Electroosmosis behavior in a porous media is described by a simplified Kozeny-Carman equation, assuming the pressure gradient due to gravity is negligent, that

$${Q}_{E} = \frac{1}{λ} \cdot \frac{{K}_{m}}{μ ε} \cdot I \qquad ( 4 )$$

where Q_{E} is the electroosmosis flow rate, λ is the ion mobility, Kₘ is the permeability, p is the dynamic viscosity, ε is the porosity, and I is the electric current.

### Acoustofiltration

Several mechanisms have been hypothesized to explain the fouling mitigation behavior in acoustofiltration. Some of these proposed mechanisms relies on the various behaviors of cavitation bubbles, including migration, oscillation, and implosion. Microstreamers are the phenomenon where in a standing wave, cavitation bubbles smaller than the resonant size migrate to the antinodes while the cavitation bubbles larger than the resonant size travel to the nodes²². Microstreaming refers to the low velocity local flow (at around 10 m/s in the range of μms) generated due to the oscillation of the cavitation bubbles. Microjet is a local high velocity flow (at around 100 m/s in the range of μms) formed from the sudden pressure gradient increase due to the collapse of a cavitation bubbles. The threshold of the formation of a cavitation bubble is governed by Blake threshold (P_{b}), which describes the minimum pressure to overcome the liquid tension to form an initial cavitation bubble of a minimum radius:

$${P}_{b} = {P}_{o} + \frac{2}{3} \sqrt{\frac{{( \frac{2 σ}{{R}_{o}} )}^{3}}{3 ( {P}_{o} + \frac{2 σ}{{R}_{o}} )}} \qquad ( 5 )$$

where Pₒ is the pressure at the location of cavitation bubble formation, σ is the liquid's surface tension, Rₒ is the initial radius of the bubble and

$$\frac{2 σ}{{R}_{o}}$$

is the surface tension of the cavitation bubble²³. After the formation of an initial cavitation bubble, the growth of this bubble is described by the Rayleigh-Plesset equation:

$$R \frac{{d}^{2} R}{d {t}^{2}} + \frac{3}{2} {( \frac{d R}{d t} )}^{2} = \frac{1}{ρ} [ ( {P}_{o} + \frac{2 σ}{{R}_{o}} ) {( \frac{{R}_{o}}{R} )}^{3 γ} - \frac{2 σ}{R} - \frac{4 μ}{R} ( \frac{d R}{d t} ) - {P}_{∞} ] \qquad ( 5 )$$

where R is the radius of the cavitation bubble, ρ is the liquid density, μ is the dynamic viscosity of the liquid, γ is the specific gas heat ratio within the bubble, and P_{∞} is the ambient pressure at infinite distance from the bubble. The Blake threshold and the Rayleigh-Plesset equation reveal that the pressure at the location of the cavitation bubble must be sufficiently large to enable the formation, growth, and eventually collapse of the cavitation bubble. In the context of acoustofiltration, the ambient pressure is the transmembrane pressure in the feed channel and the pressure at the location of the cavitation bubble can be expressed as:

$${P}_{o} = {P}_{∞} + {P}_{A} sin ( ω t ) \qquad ( 6 )$$

where P_{A} is the acoustic pressure, and ωt is the angular displacement of the external acoustic field²⁰. Whether a cavitation bubble keeps growing gradually or expands rapidly and collapse is a function on the bubble oscillation frequency (f_{b}):

$${f}_{b} = \frac{1}{2 π R} \sqrt{\frac{3 γ}{ρ} ( {P}_{o} + \frac{2 σ}{R} )} . \qquad ( 7 )$$

When the oscillation frequency of the cavitation bubble is smaller than the ultrasound frequency at the end of the compression cycle, the radial motion of the bubble continues for several motions in steady cavitation; when the oscillation frequency of the cavitation bubble is larger than the ultrasound frequency, the bubble grows rapidly and quickly ends up collapsing. In high-frequency acoustic field, the acoustic pressure tends to be insufficient for cavitation bubble generation in the rarefaction cycle, and the time is too short for bubble collapse in the compression cycle.

Another widely reported and exploited mechanism is acoustic streaming, which to a time independent velocity component apart from the oscillating component induced by ultrasound. Acoustic streaming is classified into three different types based on scales: Eckart streaming, Schlichting streaming, and microstreaming. Eckart streaming occurs when the dimension of the fluid system exceeds the wavelength, which adds an additional component to the crossflow. The maximum Eckart streaming velocity tends to increase with power input, but more with the acoustic frequency. Schlichting streaming occurs within the viscous layer at a solid boundary, incurring standing vortices which potentially help reduce the fouling settlement.

### Methods

### Materials

A customized polycarbonate membrane filtration cell 100, such as the one shown in FIGS. 1-4 and 6-11, has been manufactured at the University of Vermont Instrumentation and Model Facility. The filtration cell allows simultaneous application of an electric field across the membrane and an acoustic field towards the membrane at an angle of approximately 60° from the bottom. The effective filtration area is nominally 5 cm by 5 cm. The filtration cell withstands up to 30 psi (206.84 kPa), accommodating for microfiltration and low-pressure ultrafiltration. The nominal separation distance of the electrodes is 0.5 cm. A 0.02 μm polycarbonate membrane by Sterlitech (SKU: PCT023001) was selected to perform the filtration study.

In one embodiment, the electrodes were cut from carbon paper sheet provided by FuelCellStore (SKU:1592006), and the 500 kHz and 1 MHz piezoelectric transducer were customized by Beijing Ultrasonics Co., Ltd. The power source for the electric field and the acoustic field was provided with Siglent function/arbitrary waveform generator (SKU:SDG1025), and the power output was detected with a Tektronix oscilloscope (SKU:TDS2012). The cross-flow was provided by a Cole-Parmer peristaltic pump drive and pump head (SKU:EW-77528-10, 77200-50) and smoothed by a Cole-Parmer pulsation dampener (SKU:EW-07596-20). The transmembrane pressure was generated by a Swagelok back-pressure regulator (SKU:KBP1F0A4A5A20000). Real-time pressures at the feed inlet, retentate outlet, and permeate outlet were recorded with LOGiT pressure and temperature data loggers at a 1 second interval. The recorded pressure data was used to estimate the transmembrane pressure. The permeate was connected in Nalgene™ heavy duty vacuum carboy (SKU:72036), and the total weight was recorded with Ohaus Adventurer precision balance (SKU:AX8201/E) at a 1 second interval. The recorded weight was used to estimate the permeate flux. The schematic of the filtration system setup is shown as in FIG. 1.

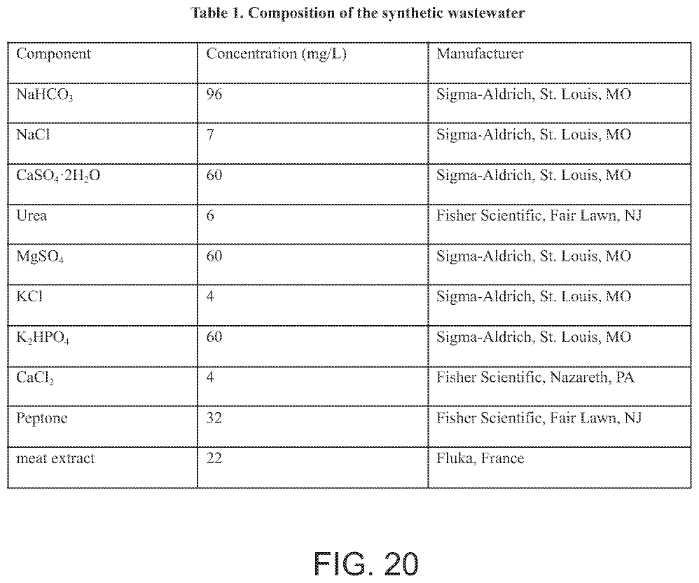

The synthetic wastewater was prepared to mimic the real wastewater matrix. Two considerations may be crucial in the context of this experiment: (1) avoidance of electrolytic reactions on the wastewater matrix components, and (2) osmotic pressure that could maintain microbe structural integrity. The first problem was avoided by applying low intensity alternating electric field setup, and a wastewater recipe in the literature was modified to address the second issue. The recipe of the synthetic wastewater, prepared with ultrapure water, is summarized in Table 1, shown in FIG. 20. Two model foulants, 300 nm silica nanoparticle (SiO₂ NPs) (nanoComposix) and Micrococcus luteus (Carolina), were used to reflect the mixture of organic and inorganic foulants in real wastewater condition. M. luteus was cultured in a VWR incubator (SKU:VWR-1545) at 25° C. for 16 hours before the experiment, and the fresh culture was immediately prepared for the experiment by extracting the cells with an Eppendorf centrifuge (SKU:5804R) and washing with 1× phosphate buffer saline. The count of SiO₂ NPs and M. luteus colony formation units (CFU) were calculated based on UV-Vis optical absorbance intensity at 350 nm and 600 nm. 6×10⁷/L SiO₂ NPs or M. luteus CFUs was nominally used as a unit of corresponding model foulant.

### Experiment Setup and Method

The primary goal of the experiment was to demonstrate and highlight the synergistic effect of the membrane fouling mitigation assisted by combined electric field and acoustic field. Two-level factorial experiment design was applied on two factors, i.e. the presence of electric field or acoustic field. For the electric field, the higher level was selected at 60 Hz 10V p-p, and the lower level was selected at the absence of the electric field; for the acoustic field, the higher level was selected at 500 kHz, and the lower level was selected at the absence of the acoustic field. The feed water in the experiments was composed of 1 unit of SiO₂ NPs, 1 unit of M. luteus in the synthetic wastewater, and the pH of the feed water was 8.3. The design is listed in Table 2. For each setup, 3 repetitions were conducted.

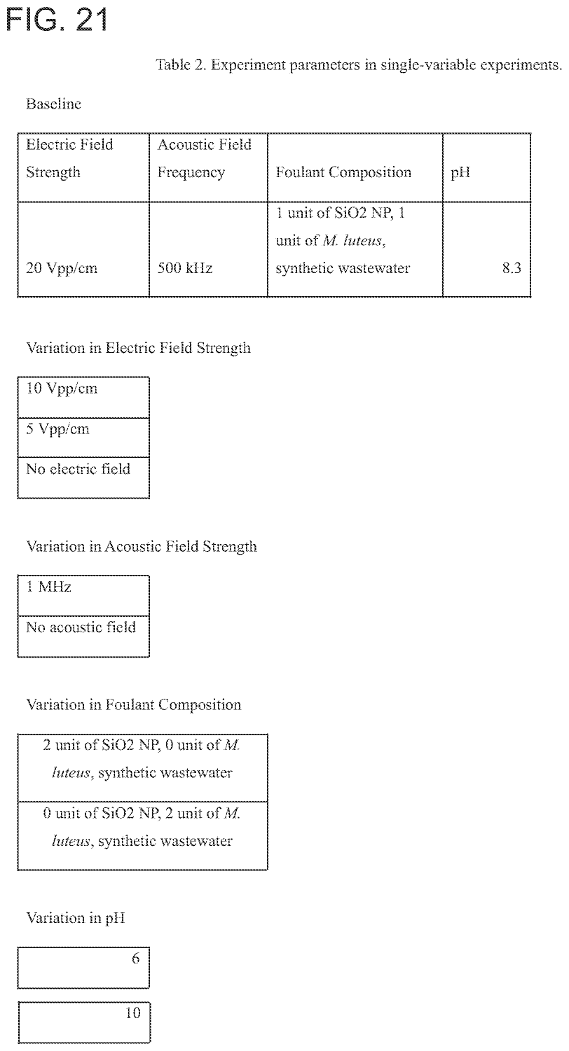

The secondary goal was to provide a preliminary understanding of the effects of electric field strength, acoustic field frequency, foulant composition, and pH of the feed water on the results of fouling mitigation in the context of synergism of electric field and acoustic field assisted membrane filtration. In each series of experiments, all but one parameter remained the same as in a baseline experiment, and that one parameter is varied across the runs. Experiment (4) in the two-level factorial design in Table 7, shown in FIG. 26, was selected as the baseline of all these experiment setups. The change of parameters is listed in Table 2, shown in FIG. 21. For each experiment setup, 3 repetitions were conducted.

The transmembrane pressure was set at 10 psi nominally, and the fluctuation was balanced out by calculating the specific flux. The crossflow velocity was calculated with the pump flow rate (specified by the manufacturer as 3.8 ml per revolution for L/S 18 tubing, set at 100 rpm) and cross-sectional area of the filtration cell as 3.04 m/min. The pH of the fresh synthetic wastewater was determined as 8.3, and used as the baseline for pH.

### Results and Discussion

### Effect of Electric Field Strength in Fouling Mitigation

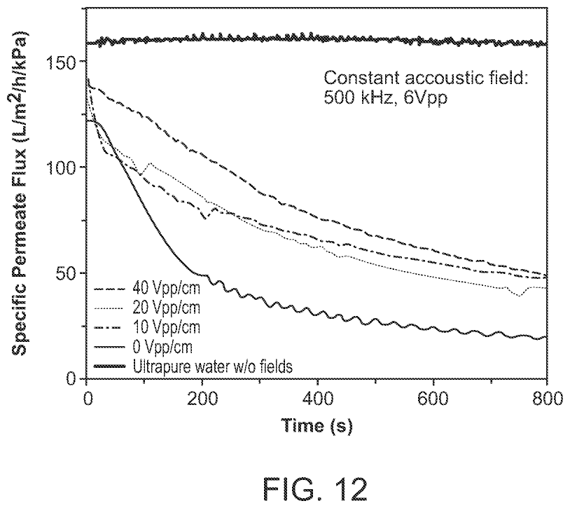

Under the simultaneous application of electric field and acoustic field, the experimental permeate flux tends to increase with the electric field strength, as demonstrated in FIG. 12. In particular, FIG. 12 is a graph which illustrates the variation of experimental flux due to electric field strength under this synergistic setup. The acoustic field frequency was kept at a constant 500 kHz, the transmembrane pressure was set at 10 psi nominally, the flow rate was 3.04 m/min, the pH was 8.3, and the foulants were a mixture of 6×10⁷/L SiO₂ NPs and 6×10⁷/L CFU M. luteus in the synthetic wastewater. This trend is consistent with the theory of electrophoresis, also confirmed by the results of other electrofiltration literature.

FIG. 12 shows a 13% specific flux recovery in the presence of 10 Vpp/cm AC electric field under a constant AC acoustic field frequency of 500 kHz at 6 Vpp. The specific flux was at 20.9 L/m2/h/kPa in the absence of electric field under the constant acoustic field frequency of 500 kHz at 6 Vpp. The specific flux recovery increased to 18% and 21% in the presence of 20 Vpp/cm and 40 Vpp/cm AC electric field, respectively, under similar acoustic field conditions. For the selected test solution, greater than 15% specific flux recovery can be achieved in presence of low-electric field strength (20 Vpp/cm) under constant acoustic field frequency. There is little addition to flux recovery at 40 Vpp/cm.

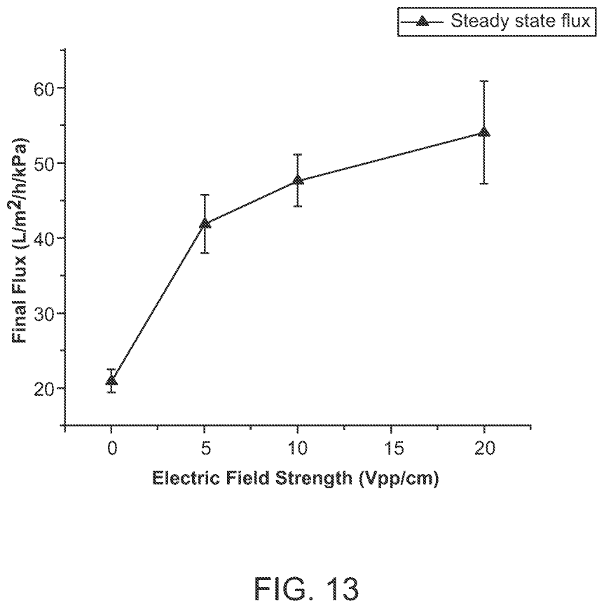

The steady state flux results (at 800 s) of experiments were summarized in FIG. 13. In particular, FIG. 13 is a graph which illustrates the variation of steady state flux results (at 800 s) due to electric field strength under synergistic setup. (Acoustic field frequency: 500 kHz. Transmembrane pressure: 10 psi. Crossflow rate: 3.04 m/min. pH: 8.3. Model foulant: 6×10⁷/L SiO₂ NPs, and 6×10⁷/L CFU M. luteus. Error bar: 1 standard deviation.) With the implementation of a 5 Vpp/cm electric field, the steady state flux increased from 20.9 L/m²-hr-kPa to 41.9 L/m²-hr-kPa on average, but this rate of increase in flux recovery declined as the implementation of a 10 Vpp/cm electric field and the 20 Vpp/cm electric field yielded results of 47.6 L/m²/h/kPa and 54.1 L/m²/h/kPa. This may be explained with the concept of critical electric field strength. A trend line was empirically fit to highlight the potential critical electric field strength and flux recovery limit.

Based on equation 3, the average electrophoretic velocity of SiO₂ NPs and M. luteus was calculated as 2.53×10⁴ m/s and 6.62×10⁴ m/s respectively at 20V/cm, 20° C. and pH8.3. This velocity is trivial compared to the flux rate of 1.04×10⁻³ m/s at 20 Vpp/cm setup. This suggests that electroosmotic process may be the dominant fouling mitigation effect in this specific setup.

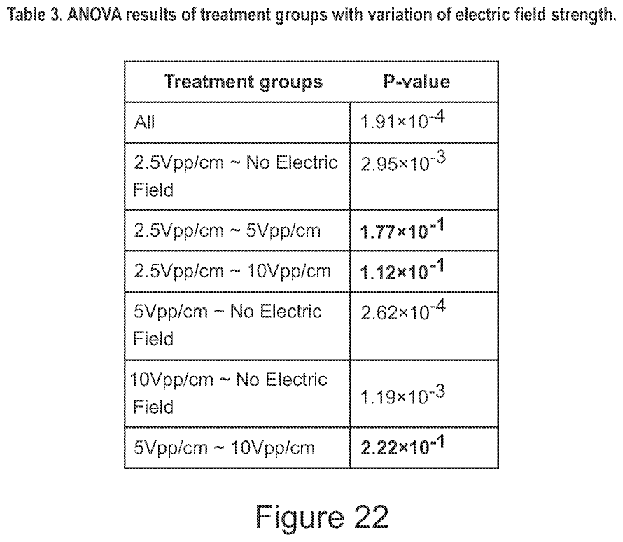

An overall ANOVA test was performed on the steady state permeate flux results related to varying electric field strengths, and ANOVA tests were applied to paired treatment groups, and summarized in Table 3, shown in FIG. 22. The significance level was selected as 0.05, and the result suggested that all treatment groups with electric field was significantly different from the group without electric field, however, the increase of steady state flux due to the increase of electric field strength was not statistically significant. This can be confirmed in FIG. 13, where the increase in flux recovery slowed down with the increase of the electric field strength, and the standard deviation of the steady state flux also increased.

### Effect of Acoustic Field Frequency in Fouling Mitigation

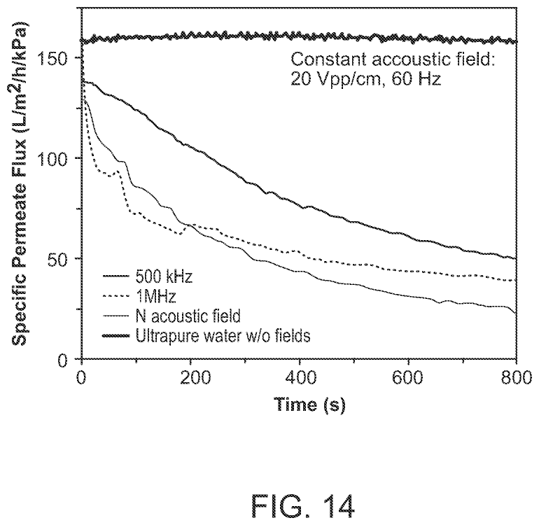

Based on the aforementioned bubble oscillation frequency, the higher acoustic frequency induces less cavitation collapse behavior and therefore less fouling mitigation effect. The variation of acoustic frequency under the synergistic setup of combined fields has been demonstrated in FIG. 14, confirming with this theoretical analysis.

The specific flux reached 23.8 L/m2/h/kPa in the absence of acoustic field under a constant 20 Vpp/cm electric field strength. FIG. 14 shows a 19% specific flux recovery in the presence of 500 kHz acoustic field under a constant 20 Vpp/cm electric field strength. On the contrary, only 9% specific flux was recovered when the acoustic frequency was increased to 1 MHz under similar electric field strength.

The electric field strength was kept constant at 20 Vpp/cm, the transmembrane pressure was set at 10 psi nominally, the flow rate was 3.04 m/min, the pH was 8.3, and the foulants were a mixture of 6×10⁷/L SiO₂ NPs and 6×10⁷/L CFU M. luteus in the synthetic wastewater. The implementation of a 500 kHz acoustic field increased the steady state permeate flux from 23.8 L/m²/h/kPa to 54.1 L/m²/h/kPa, compared to that the implementation of the 1 MHz acoustic field increased the steady state permeate flux to 38.0 L/m²/kPa. The better performance at 500 kHz suggests that the mitigation mechanisms attributed to cavitation may be the dominant effect in this setup, as the aforementioned discussion on equation (7) suggests that a lower frequency could induce better cavitation results. An inspection of equation (5) suggests that the Blake threshold may be reduced by initial air bubbles, which could be induced from the pulsation of the pumping system.

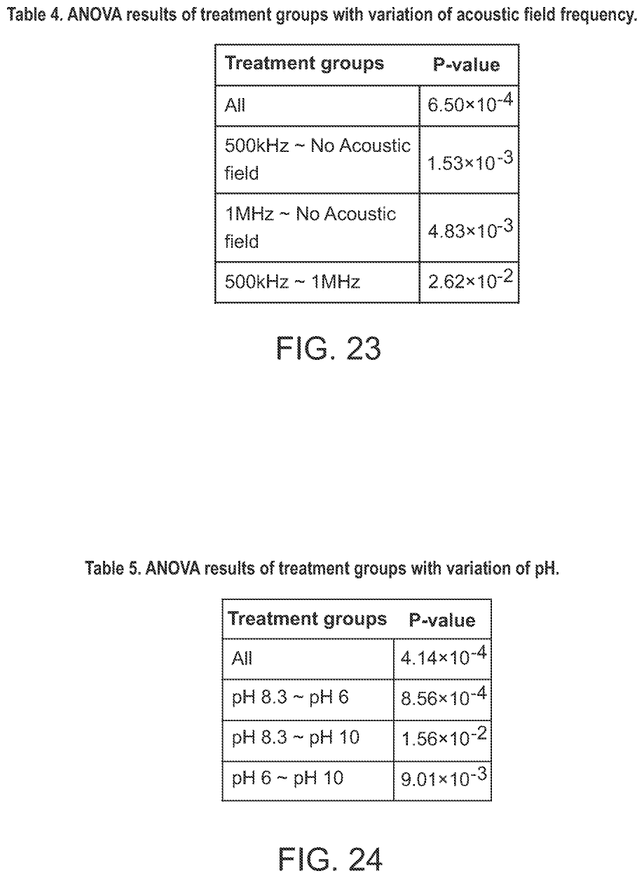

An overall ANOVA test was performed on the steady state flux results of results related to varying acoustic field frequencies, and ANOVA tests were also performed on paired treatment groups. The results are summarized in Table 4, shown in FIG. 23. At a selected significance level of 0.05, the ANOVA tests suggest the treatment groups had significantly different results.

The results in FIG. 14 suggest cavitation activities might be a key mechanism for fouling mitigation under our experimental conditions. The inventors speculate by changing the liquid surface tension, the surfactant-like properties of synthetic-wastewater with foulant particles might have lowered the pressure threshold for cavitation. Another argument in favor of cavitation as the key mechanism is that the results are difficult to be explained with acoustic streaming theories. Given that the characteristic length of the filtration chamber (50 mm nominal) in the direction of acoustic wave propagation is considerably greater than the acoustic wavelength (1-2 mm), the most likely type of acoustic streaming in this apparatus would be Eckart streaming. However, Eckart streaming is characterized by increasing streaming velocity with rising acoustic field intensity and frequency. This characteristic eliminates the possibility of Eckart streaming mechanism in this system because the results already showed a decrease in specific flux recovery when acoustic field frequency increased from 500 kHz to 1 MHz under a constant electric field strength. These observations suggest that the mechanisms associated with cavitation might dominate over acoustic streaming activities under a constant AC electric field.

### Effect of pH in Fouling Mitigation

The foulant conditions, including but not limited to size, hydrophobicity, surface charge, surface chemistry, have been known to affect the filtration behavior. In one study, due to practical limitation, the behavior of foulant conditions in synergistic setup of acoustic field and electric field could not be exhaustively tested. Therefore, pH was altered to modify the surface charge and zeta potential of the foulants, which also influenced the size of the foulants.

The membrane surface charge or surface zeta potential was measured by a surface zeta potential cell equipped on a dynamic light scattering (DLS) instrument (Malvern Instruments ZetaSizer Nano ZS). The membrane samples were cut into 4 mm×5 mm pieces and attached by double coated adhesive tapes (Tedpella) to the cell. The cell was placed in a standard 12 mm² polystyrene cuvette (Fisher Scientific Co, Pittsburgh, PA) filled with the dispersant (i.e., synthetic wastewater within the pH range 6-10) and tracer particles (300 nm carboxylated latex particles, Sigma, USA). The cuvette and cell were then placed in the temperature controlled ZetaSizer instrument at a temperature of 25±1° C. The pH was measured using a pH-meter (Orion model 420A, Boston, MA, USA) and adjusted by addition of NaOH and HCl solutions.

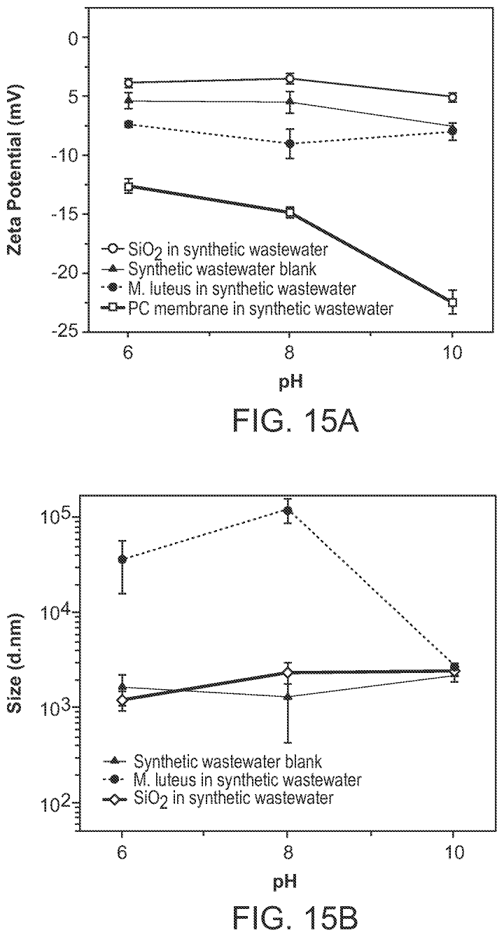

FIGS. 15A and 15B show the zeta potentials of the membrane and foulants, and the hydrodynamic sizes of the foulants. pH had negligible effect on the zeta potentials of all foulants including organics, SiO2, and M. luteus (FIG. 15A). However, the polycarbonate membrane became increasingly negatively charged as the pH changed from 6 to 10 (FIG. 15a). pH had negligible effect on the hydrodynamic size of dissolved organics as well as SiO2 in the synthetic wastewater (FIG. 15B). However, the hydrodynamic size of M. luteus increased when the pH was changed from 6 to 8.3, and then decreased to a size that is almost similar to that of dissolved organics at pH 10 (FIG. 15B). These results suggest that pH of synthetic wastewater can have significant impact on foulant particle-membrane surface charge interactions as well as the hydrodynamic stability of particulate foulants.

The foulant zeta potential was measured Malvern Zetasizer Nano ZSP, and disposable capillary cells (SKU:DTS1070). Measurements were taken separately for M. luteus, SiO2 NPs, and large molecules (i.e., protein) in the synthetic wastewater. The foulants were measured in the dispersion of synthetic wastewater with pH adjusted within the range 2-10, adjusted with NaOH and HCl solution. The measurement was performed at a temperature set at 25° C. The result is listed in FIG. 15A with the membrane surface zeta potential measurements.

The variation of the experimental permeate flux did not support a monotonical trend between pH and the permeate flux, as demonstrated in FIG. 7. The electric field strength was kept at 20 Vpp/cm, a 500 kHz acoustic field was applied, the transmembrane pressure was set at 10 psi nominally, the flow rate was 3.04 m/min, and the foulants were a mixture of 6×10⁷/L SiO₂ NPs and 6×10⁷/L CFU M. luteus in the synthetic wastewater. The steady state permeate flux at the unadjusted pH of the synthetic wastewater (8.3) is 54.1 L/m²/h/kPa on average, which decreased to 18.3 L/m²/h/kPa and 33.7 L/m²/h/kPa on average when adjusted to pH 6 and pH 10 respectively. As summarized in FIG. 15A, the zeta potential and surface charge of the foulants and membrane tend to induce stronger repulsive forces as the pH increases. While this repulsive force contributed to reduce fouling layer formation on the membrane surface, it also kept the foulants from forming larger agglomerates before reaching the membrane. It has been reported by researchers that smaller foulants tend to form less porous fouling layer, which in turn exacerbated the fouling problem.

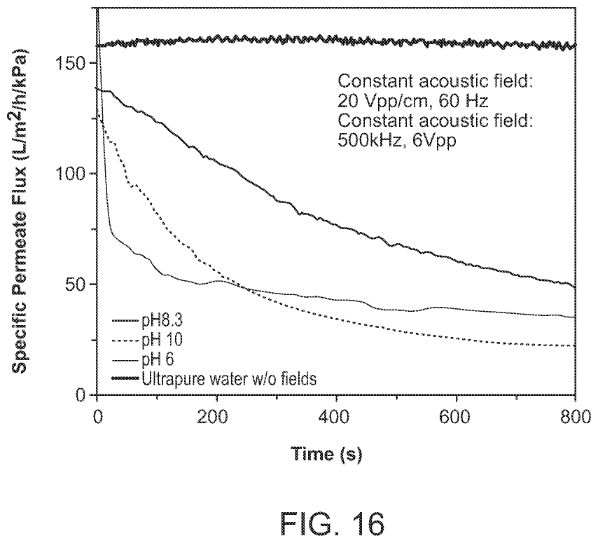

FIG. 16 shows the highest specific flux (41.9 L/m2/kPa) at pH 8.3 when compared with pH 6 or 10 during simultaneous application of AC electric and acoustic fields. However, the specific flux decreased by 22% when the pH was changed to 6. Similarly, the specific flux decreased by 13% when the pH was changed to pH 10. These results suggest that pH of synthetic wastewater can significantly impact the permeate flux enhancement, and thereby flux mitigation, during simultaneous application of both fields.

Thus, the results in FIG. 16 may be interpreted to show that at the unadjusted pH of the synthetic wastewater, a balance was achieved between the effects of the repulsive interactions and the size of the foulants, which achieved a local optimization for flux recovery.

An overall ANOVA test was performed on the treatment groups of varying pH, and separate ANOVA tests were performed on paired treatment groups. The results are listed in Table 5, shown in FIG. 24, suggesting all treatment groups are significantly different from each other with a selected significance level of 0.05.

### Effect of Model Foulant in Fouling Mitigation

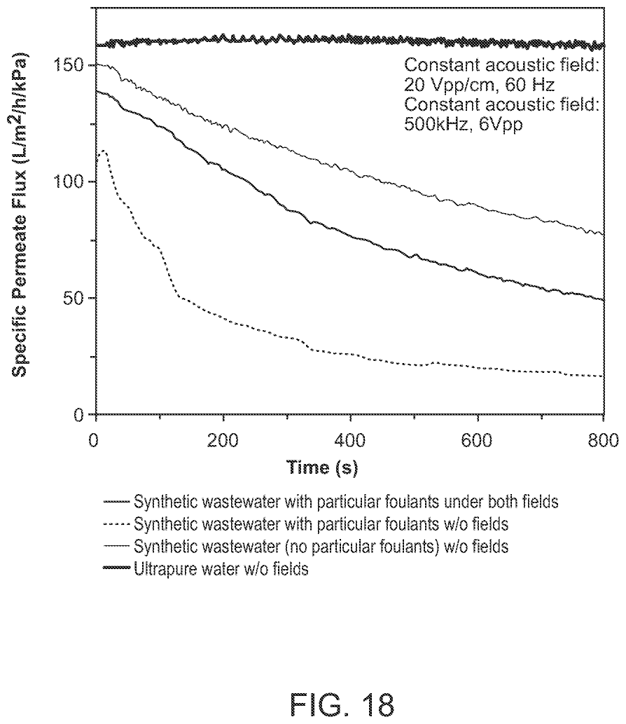

Another foulant condition that was investigated was the composition of model foulants. In the study, the proportion of SiO₂ NPs and M. luteus in the synthetic wastewater dispersion was changed. The variation of permeate flux under the combined field was illustrated as in FIG. 18, where the mixture (6×10⁷/L SiO₂ NPs, and 6×10⁷/L CFU M. luteus in synthetic wastewater) group yielded 54.1 L/m²/h/kPa on average, the SiO₂ NPs only (1.2×10⁸/L SiO₂ NPs in synthetic wastewater) group yielded 67.1 L/m²/h/kPa on average, and the M. luteus only (1.2×10⁸/L CFU M. luteus in synthetic wastewater) group yielded 28.1 L/m²/h/kPa. The electric field was kept at 20 Vpp/cm constant, a 500 kHz acoustic field was applied, the transmembrane pressure was set at 10 psi nominally, the flow rate was 3.04 m/min, and the pH was 8.3. Given the relatively short experiment duration (steady state flux measured at 800 s), the stronger fouling behavior of the M. luteus only group cannot be explained by biofouling. Compared to SiO₂ NPs, M. luteus has a more complex surface feature. M. luteus cell has an overall negative surface charge due to the phosphate group on the lipids that compose the cell membrane. However, M. luteus surface also contains teichuronic acid, which is involved in cation assimilation. The complex composition of M. luteus cell membrane results in non-uniform distribution of surface charge on the cells with positively charged local spots. This may cause difficulty in removing the cells after attaching to the filtration membrane by electric field and acoustic field, ending up with reduced permeate flux due to increased M. luteus concentration.

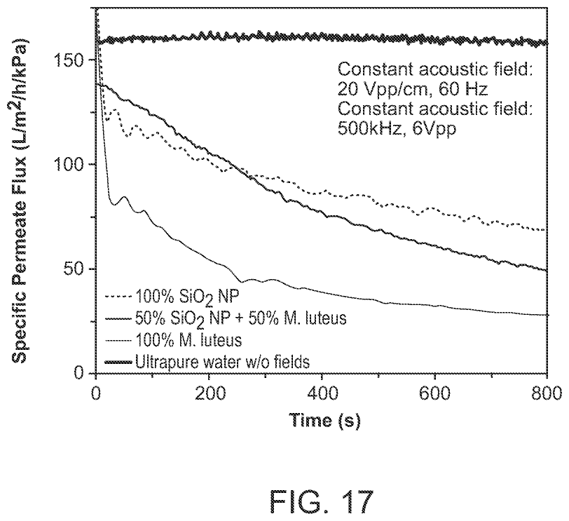

FIG. 17 shows the effect of foulant type and composition on the specific flux recovery during simultaneous application of AC electric and acoustic fields. The specific flux was at 41.9 L/m2/h/kPa in synthetic-wastewater containing 1.2×10⁸ particles/L of a mixture of SiO2 and M. luteus at 50% each by count. The specific flux increased by 16% of clean water specific flux in synthetic-wastewater containing 1.2×10⁸ count/L SiO2 (no bacteria). On the contrary, the specific flux decreased by 9% in synthetic-wastewater water containing 1.2×10⁸ CFU/L M. luteus (no SiO2). Interestingly, the average of the fluxes obtained with 100% SiO2 and 100% M. luteus in synthetic-wastewaters was at 47.6 L/m2/h/kPa, which is close to the flux obtained with the mixture of SiO2 and M. luteus (41.9 L/m2/h/kPa). These results demonstrate both the foulant type and composition are likely to impact the flux recovery, and thereby fouling, during simultaneous application of AC electric and acoustic fields.

Due to rapid fouling rate and the relatively short experimental duration, the severe fouling behavior of M. luteus is rather a physical process than a biological process. An explanation for the stronger fouling propensity of M. luteus could be that it has a more complex surface feature than SiO2. M. luteus has an overall negative surface charge due to the phosphate groups on the lipids hat compose the cell membrane. However, M. luteus surface also contains teichuronic acid, which is involved in cation assimilation. This complex composition of M. luteus cell membrane results in non-uniform distribution of localized negative and positive charges on the cell surface. The binding of positive charges with the negatively charged polycarbonate membrane surface increases the binding of bacteria to the membrane surface. Ibis increased binding increases biofouling, and thereby reduces the specific flux.

FIG. 17 illustrates the effect of foulant type on specific flux recovery during simultaneous application of AC electric and acoustic fields. The specific flux was at 41.9 L/m2/h/kPa in synthetic-wastewater containing 1.2×10⁸ particles/L of a mixture of SiO2 and M. luteus at 50% each by count. The specific flux increased by 16% in synthetic-wastewater containing 1.2×108 count/L SiO2 (no bacteria). On the contrary, the specific flux decreased by 93% in synthetic-wastewater containing 1.2×108 CFU/L M. luteus (no SiO2). Experimental conditions: AC electric field parameters included 20 Vpp/cm and 60 Hz; acoustic field parameters included 6 Vpp and 500 kHz; transmembrane pressure maintained at 68.95 kPa; and crossflow rate at 3.04 m/min.

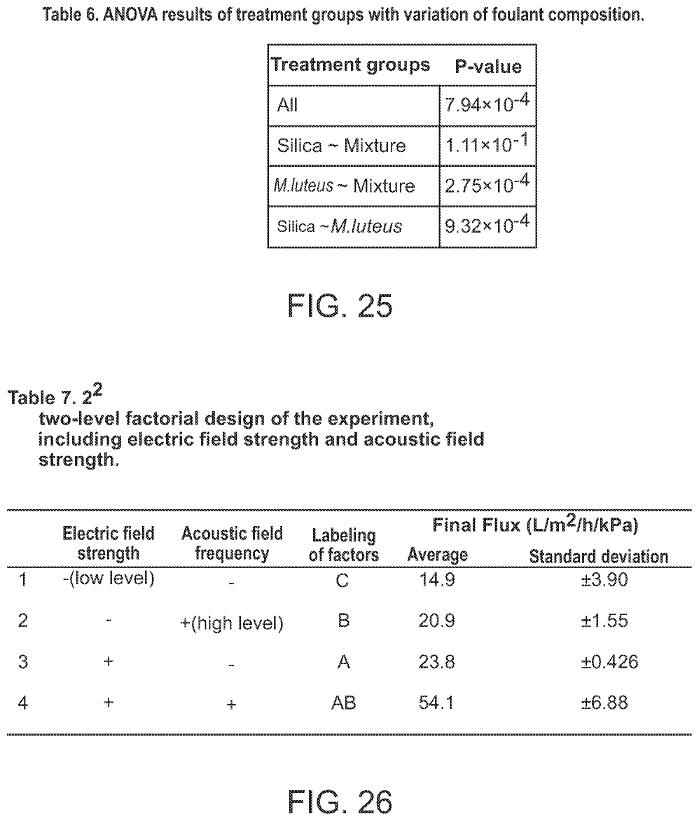

An overall ANOVA test was performed on all the treatment groups with varying foulant compositions, and ANOVA tests were performed on paired treatment groups. The results are summarized in Table 6, shown in FIG. 25. With a significance level set at 0.05, the only pair that did not show a significant difference was the group of SiO2 NPs only and the group of mixture. This confirms with the earlier conclusion that M. luteus contributes to the larger portion of the fouling activity in the setup.

### The Synergistic Effect of Electric Field and Acoustic Field

In this study, one can determine the clean water flux by filtration of ultrapure water with the system setup, and use the result as the baseline to determine the initial flux.

Experiments were also performed without the particulate model foulants to highlight the separate fouling capacity of the synthetic wastewater matrix and the model foulants. The results of the 2² two-level factorial design of the experiment to highlight the synergistic effect has been plotted as in FIG. 18.

FIG. 18 illustrates the variation of experimental permeate flux due to presence and absence of the electric or acoustic field. From top to bottom: (1) filtration of ultrapure water without electric field or acoustic field; (2) filtration of synthetic wastewater (no model foulants) without electric field or acoustic field; (3) filtration of mixed foulants in synthetic wastewater with 20 Vpp/cm electric field and 500 kHz acoustic field; (4) filtration of mixed foulants in synthetic wastewater with 20 Vpp/cm electric field; (5) filtration of mixed foulants in synthetic wastewater with 500 kHz acoustic field; and (6) filtration of mixed foulants in synthetic wastewater without electric field or acoustic field. Transmembrane pressure: 10 psi. Crossflow rate: 3.04 m/min. pH: 8.3. Model foulant (if applicable): 6×10⁷/L SiO2 NPs, and 6×10⁷/L CFU M. luteus.

FIG. 18 illustrates the specific permeate flux curves for four baseline experiments. The clean water flux (without any foulants and the fields) was found to be 160 L/m2/h/kPa. 91% of clean water flux was lost under severe fouling conditions. In these experiments, a severe fouling condition was defined as the fouling caused by synthetic-wastewater containing 1.2 ′ 108 particles/L of a mixture of SiO2 and M. luteus at 50% each by count at pH 8.3. But when combined AC electric and acoustic fields were applied, additional 21% of clean water flux was recovered under similar severe fouling condition. Furthermore, 52% of clean water flux was lost under the synthetic-wastewater fouling conditions (i.e., dissolved organic foulants, no particulate foulants) alone suggesting that 39% flux lost was due to particulate fouling. 21% clean water flux recovery even under un-optimized field conditions suggests that the combined fields are likely to mitigate particulate fouling under our experimental conditions. These results suggest that it might further be possible to significantly affect both particulate and dissolved organic foulants upon tuning parameters of the combined fields (e.g., field strength and frequency) to specific water chemistry and composition. Thus, these results establish the feasibility of flux recovery with combined AC electric and acoustic fields even under severe fouling conditions.

FIG. 18 clearly demonstrates the synergistic effect of AC electric and acoustic fields (21%>4%+6%). A specific flux of 14.9 L/m2/h/kPa was obtained in the absence of the both fields. When both fields were simultaneously applied, the specific flux was enhanced by 21% under the synergistic effect. However, the specific flux was enhanced only by 4% in the presence of AC electric field alone and only by 6% in the presence of acoustic field alone. The specific fluxes under different treatments are summarized in Table 1 and used for 22 two-level factorial analysis.

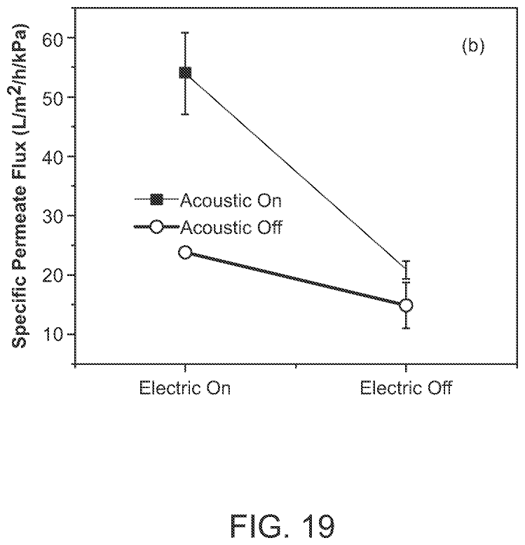

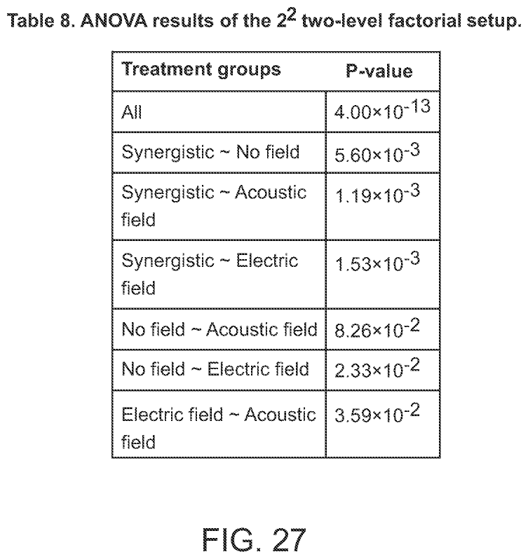

An overall ANOVA test was performed across all treatment groups, and the same analysis was applied to each pair of treatments. The p-value of ANOVA tests here were summarized in Table 8, shown in FIG. 27. The significance level was selected at 0.05, and the only pair exceeding this threshold was the pair of the group without treatment of fields and the group with treatment of acoustic field only. This is due to the relatively large coefficient of variation of the group without treatment, which is also shown in FIG. 19.

In the Table 7, shown in FIG. 26, of two-level factorial design, ‘−’ indicates a low level is taken for the factor, ‘+’ indicates a high level is taken for the factor, and the sums c, b, a, and ab were used to label different experiment setups. After running the corresponding experiments, to evaluate the effect of the factors, first the impact of the individual factors was calculated. When factor (B) is at a low level, the effect of (A) is calculated as [a−c]/n, where n is the number of replicates; when (B) is at a high level, the effect of (A) is calculated as [ab−b]/n. The average effect of (A) is calculated as the average of these two values that

$$A = \frac{1}{2 n} \{ a b + a - b - c \} \qquad ( 8 )$$

Similarly, the average effect of (B) is calculated as the average of these two values that

$$B = \frac{1}{2 n} \{ a b - a + b - c \} \qquad ( 9 )$$

The effect of (AB) is calculated by the difference between two effects of (A) at the high and the low level that

$$A B = \frac{1}{2 n} \{ a b - a - b + c \} \qquad ( 10 )$$

Based on equations (8)-(10), it was calculated that A=21.0, B=18.2, and AB=12.1. The effect of each is visualized in FIG. 19. The positive value of AB suggests that the interaction of electric field and acoustic field positively contributed to fouling mitigation, referring to the synergistic effect that the flux recovery under the combined field was larger than the numerical sum of the flux recovery under each field separately. As A, B and AB are of the same order of magnitude, this suggests that the extra flux recovery contributed by the interaction of the electric field and acoustic field is significant in this setup. The result that A>B>AB suggests that the flux recovery under the electric field is larger than that under the acoustic field, which in turn is larger than that due to the interaction of the electric field and acoustic field.

The above-described experiments illustrate the synergistic effect in membrane fouling mitigation under the combined effects of an electric field and an acoustic field. The inventors hypothesize that the application of the acoustic field modified certain properties of the foulant particles or the foulant layer that enhanced the effect of the electric field in fouling mitigation.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

### REFERENCES

Additional references are cited in Specification and Examples, and all are incorporated by reference in their entirety.
1. Boretti, A.; Rosa, L., Reassessing the projections of the World Water Development Report. npj Clean Water 2019, 2, (1).
2. Yalcinkaya, F.; Boyraz, E.; Maryska, J.; Kucerova, K., A Review on Membrane Technology and Chemical Surface Modification for the Oily Wastewater Treatment. Materials (Basel) 2020, 13, (2).
3. Technology trends in membrane filtration use. Filtration+Separation 2018, 55, (1), 30-33.
4. Du, X.; Shi, Y.; Jegatheesan, V.; Haq, I. U., A Review on the Mechanism, Impacts and Control Methods of Membrane Fouling in MBR System. Membranes (Basel) 2020, 10, (2).
5. Jafari, M.; D'Haese, A.; Zlopasa, J.; Comelissen, E. R.; Vrouwenvelder, J. S.; Verbeken, K.; Verliefde, A.; van Loosdrecht, M. C. M.; Picioreanu, C., A comparison between chemical cleaning efficiency in lab-scale and full-scale reverse osmosis membranes: Role of extracellular polymeric substances (EPS). Journal of Membrane Science 2020, 609.
6. Wang, Z.; Ma, J.; Tang, C. Y.; Kimura, K.; Wang, Q.; Han, X., Membrane cleaning in membrane bioreactors: A review. Journal of Membrane Science 2014, 468, 276-307.
7. Asif, M. B.; Maqbool, T.; Zhang, Z., Electrochemical membrane bioreactors: State-of-the-art and future prospects. Sci Total Environ 2020, 741, 140233.
8. Li, C.; Guo, X.; Wang, X.; Fan, S.; Zhou, Q.; Shao, H.; Hu, W.; Li, C.; Tong, L.; Kumar, R. R.; Huang, J., Membrane fouling mitigation by coupling applied electric field in membrane system: Configuration, mechanism and performance. Electrochimica Acta 2018, 287, 124-134.
9. Aghapour Aktij, S.; Taghipour, A.; Rahimpour, A.; Mollahosseini, A.; Tiraferri, A., A critical review on ultrasonic-assisted fouling control and cleaning of fouled membranes. Ultrasonics 2020, 108, 106228.
10. Ahmad, A. L.; Che Lah, N. F.; Ismail, S.; Ooi, B. S., Membrane Antifouling Methods and Alternatives: Ultrasound Approach. Separation & Purfication Reviews 2012, 41, (4), 318-346.
11. Warsinger, D. M.; Swaminathan, J.; Guillen-Burrieza, E.; Arafat, H. A.; Lienhard V, J. H., Scaling and fouling in membrane distillation for desalination applications: A review. Desalination 2015, 356, 294-313.
12. Tarleton, E. S. W., R. J., Microfiltration Enhancement by Electrical and Ultrasonic Force Fields. Filtration & Separation 1990, 27, (3), 192-4.
13. Kyllbnen, H. Electrically or ultrasonically enhanced membrane filtration of wastewater. Lappeenranta University of Technology, Lappeenranta, Finland, 2005.
14. Chang, E. E.; Yang, S.-Y.; Huang, C.-P.; Liang, C.-H.; Chiang, P.-C., Assessing the fouling mechanisms of high-pressure nanofiltration membrane using the modified Hermia model and the resistance-in-series model. Separation and Purification Technology 2011, 79, (3), 329-336.
15. Hermia, J., Constant Pressure Blocking Filtration Laws—Application to Power-Law Non-Newtonian Fluids. Transactions of the Institution of Chemical Engineers 1982, 60, (3), 5.
16. Belfort, G., Fluid Mechanics in Membrane Filtration: Recent Developments. Journal of Membrane Science 1989, 40, (2), 25.
17. Damak, K. A., Abdelmoneim; Zeghmati, Belkacem; Schmitz, Philippe, A New Navier-Stokes and Darcy's Law Combined Model for Fluid Flow in Crossflow Filtration Tubular Membranes. Desalination 2004, 161, (1), 11.
18. Kobayashi, K.; Hakoda, M.; Hosoda, Y.; Iwata, M.; Yukawa, H., Electroosmotic flow through particle beds and electroosmotic pressure distribution. Journal of Chemical Engineering of Japan 1979, 12, (6), 3.
19. Lamminen, M.; Walker, H. W.; Weavers, L. K., Mechanisms and factors influencing the ultrasonic cleaning of particle-fouled ceramic membranes. Journal of Membrane Science 2004, 237, (1-2), 213-223.
20. Qasim, M.; Darwish, N. N.; Mhiyo, S.; Darwish, N. A.; Hilal, N., The use of ultrasound to mitigate membrane fouling in desalination and water treatment. Desalination 2018, 443, 143-164.
21. Lamminen, M. O.; Walker, H. W.; Weavers, L. K., Cleaning of particle-fouled membranes during cross-flow filtration using an embedded ultrasonic transducer system. Journal of Membrane Science 2006, 283, (1-2), 225-232.
22. Muthukumaran, S.; Kentish, S. E.; Stevens, G. W.; Ashokkumar, M., Application of Ultrasound in Membrane Separation Processes: A Review. Reviews in Chemical Engineering |2006, 22, (3).
23. Abdelrasoul, A.; Doan, H., Ultrasound for Membrane Fouling Control in Wastewater Treatment and Protein Purification Downstream Processing Applications. In Advances in Membrane Technologies, Abdelrasoul, A., Ed. IntechOpen: London, U K, 2020.
24. Production of Biofuels and Chemicals with Ultrasound. Springer Netherlands: 2015.
25. Thompson, L. H.; Doraiswamy, L. K., Sonochemistry: Science and Engineering. Ind. Eng. Chem. Res. 1999, 38, (4), 35.
26. Marshall, J. S.; Wu, J., Acoustic streaming, fluid mixing, and particle transport by a Gaussian ultrasound beam in a cylindrical container. Physics of Fluids 2015, 27, (10).
27. Wu, J., Acoustic Streaming and Its Applications. Fluids 2018, 3, (4).
28. Keswani, M. Megasonic Cleaning of Wafers in Electrolyte Solutions: Possible Role of Electro-acoustic and Cavitation Effects. The University of Arizona, 2008.
29. Polo-López, M. I.; Garcia-Fernández, I.; Oller, I.; Fernández-Ibáñez, P., Solar disinfection of fungal spores in water aided by low concentrations of hydrogen peroxide. Photochem Photobiol Sci 2011, 10, (3), 381-8.
30. Meng, F.; Zhang, H.; Yang, F.; Zhang, S.; Li, Y.; Zhang, X., Identification of activated sludge properties affecting membrane fouling in submerged membrane bioreactors. Separation and Purification Technology 2006, 51, (1), 95-103.
31. Chiu, T. Y., Electrically Assisted Microfiltration of Whey Suspensions using Non-Circular Multichannel Ceramic Membranes. Separation Science and Technology 2013, 48, (1), 84-92.
32. Huang, J.; Wang, Z.; Zhang, J.; Zhang, X.; Ma, J.; Wu, Z., A novel composite conductive microfiltration membrane and its anti-fouling performance with an external electric field in membrane bioreactors. Sci Rep 2015, 5, 9268.
33. Rajha, H. N.; Boussetta, N.; Louka, N.; Maroun, R. G.; Vorobiev, E., Effect of alternative physical pretreatments (pulsed electric field, high voltage electrical discharges and ultrasound) on the dead-end ultrafiltration of vine-shoot extracts. Separation and Purification Technology 2015, 146, 243-251.
34. Lee, H.-H.; Weng, Y.-H.; Li, K.-C., Electro-ultrafiltration study on Aldrich humic substances with different molecular weights. Separation and Purification Technology 2008, 63, (1), 23-29.
35. Sun, J.; Hu, C.; Tong, T.; Zhao, K.; Qu, J.; Liu, H.; Elimelech, M., Performance and Mechanisms of Ultrafiltration Membrane Fouling Mitigation by Coupling Coagulation and Applied Electric Field in a Novel Electrocoagulation Membrane Reactor. Environ Sci Technol 2017, 51, (15), 8544-8551.
36. De Bony, J.; Lopez, A.; Gilleron, M.; Welby, M.; Laneelle, G.; Rousseau, B.; Beaucourt, J. P.; Tocanne, J. F., Transverse and lateral distribution of phospholipids and glycolipids in the membrane of the bacterium Micrococcus luteus. Biochemistry 2002, 28, (9), 3728-3737.
37. Deng, L. L.; Alexander, A. A.; Lei, S.; Anderson, J. S., The Cell Wall Teichuronic Acid Synthetase (TUAS) Is an Enzyme Complex Located in the Cytoplasmic Membrane of Micrococcus luteus. Biochem Res Int 2010, 2010, 395758.
38. Ward, J. B., Teichoic and Teichuronic Acids: Biosynthesis, Assembly, and Location. Microbiol Rev 1981, 45, (2), 33.
39. Tang, T.; Dong, B.; Huang, L., Agglomeration of particles by a converging ultrasound field and their quantitative assessments. Ultrason Sonochem 2021, 75, 105590.

What is claimed is:

1. A membrane filtration cell comprising:
a fluid passageway;
a filtration membrane positioned within the passageway, the filtration membrane dividing the fluid passageway into two chambers, a retentate chamber and a permeate chamber;
a first electrode positioned in the retentate chamber;
a second electrode positioned in the permeate chamber;
wherein the first electrode and the second electrode are configured to apply an electric field across the filtration membrane; and
an acoustic device configured to apply an acoustic field across the retentate chamber, wherein the synergistic combination of the electric field and the acoustic field prevents fouling on the filtration membrane.

2. The membrane filtration cell of claim 1, wherein the acoustic device is a piezoelectric transducer.

3. The membrane filtration cell of claim 1, wherein the acoustic device is positioned at an angle relative to the filtration membrane such that the acoustic field is not perpendicular to the filtration membrane.

4. The membrane filtration cell of claim 3, wherein the acoustic device is positioned at an angle between about 10° and about 80° relative to the filtration membrane.

5. The membrane filtration cell of claim 1, wherein the filtration membrane is configured as a cross flow filtration system.

6. The membrane filtration cell of claim 1, wherein the first electrode extends substantially parallel to the filtration membrane, and wherein the second electrode extends substantially parallel to the filtration membrane.

7. The membrane filtration cell of claim 1, wherein a distance between the first electrode and the second electrode is less than approximately 5 millimeters.

8. The membrane filtration cell of claim 1, wherein the first and the second electrodes are made from carbon paper.

9. The membrane filtration cell of claim 1, further comprising a first plate having a concavity which forms the retentate chamber, the first plate having an inlet port and an outlet port for the retentate chamber.

10. The membrane filtration cell of claim 9, further comprising a second plate having a concavity which forms the permeate chamber, the second plate having an outlet port for the permeate chamber.

11. The membrane filtration cell of claim 10, wherein the first plate is stacked with the second plate, with the filtration membrane positioned between the first and second plate.

12. The membrane filtration cell of claim 11, wherein the first plate includes a groove configured to receive the acoustic device.

13. The membrane filtration cell of claim 12, wherein the groove has an angled wall between about 10° and about 80° relative to the filtration membrane, and the acoustic device is coupled to the angled wall such that the acoustic device is configured to apply an acoustic wave at an angle relative to the filtration membrane.

14. The membrane filtration cell of claim 1, further comprising:
a first power source configured to apply the electric field across the filtration membrane; and
a second power source configured to apply the acoustic field across the retentate chamber.

15. A method of filtering water, the method comprising:
providing a filtration membrane in a fluid passageway, the filtration membrane dividing the fluid passageway into a retentate chamber and a permeate chamber;
flowing water into the retentate chamber;
generating an electric field across the filtration membrane with a first electrode positioned in the retentate chamber and a second electrode positioned in the permeate chamber; and
generating an acoustic field across the retentate chamber with an acoustic device, wherein the synergistic combination of the electric field and the acoustic field prevents fouling on the filtration membrane.

16. The method of claim 15, wherein the acoustic device is a piezoelectric transducer.

17. The method of claim 15, wherein the acoustic device is positioned at an angle relative to the filtration membrane such that the acoustic field is not perpendicular to the filtration membrane.

18. The method of claim 17, wherein the acoustic device is positioned at an angle between about 10° and about 80° relative to the filtration membrane.
